(19) United States
(12) Patent Application Publication
(10) Pub. No.: US 2006/0196528 A1
(43) Pub. Date: Sep. 7, 2006

(54) Apparatus and method for washing pots and pans

(75) Inventor: Michael F. Jarvis, Huntingdon Valley, PA (US)

Correspondence Address: HOWSON AND HOWSON, SUITE 210, 501 OFFICE CENTER DRIVE, FT WASHINGTON, PA, 19034, US

(73) Assignee: Insinger Machine Company, Philadelphia, PA (US)

(21) Appl. No.: 11/074,269

(22) Filed: Mar. 7, 2005

(51) Int. Cl. B08B 3/02

(52) U.S. Cl. 134/25.2; 134/57 D; 134/111; 134/186

(57) ABSTRACT

A sink having a front wall, a rear wall, an opposed pair of sidewalls, and vertically-extending corner sections connecting the front and rear walls to the sidewalls. A pump circulates cleaning fluid withdrawn from the sink to at least one nozzle located in each corner section of the sink to create a whirlpool circulation pattern within the sink. The corner sections are formed as chamfers, or are rounded, and each nozzle is directed to emit a flow of cleaning fluid substantially parallel to and closely along an adjacent one of the front, rear and sidewalls of the sink. Preferably, the flows of cleaning fluid are directed within two to three inches of the adjacent one of the front, rear and sidewalls of the sink. A method of washing pots and pans is also disclosed.

### BACKGROUND OF THE INVENTION

The present invention relates to washing articles by soaking the articles in a sink, or tank, through which a cleaning fluid is continuously circulated, and more particularly, the present invention relates to a power soak sink and method for washing pots, pans, and other kitchen related articles.

Restaurants, institutions and other eating facilities often use a relatively-large wash tank, or sink, for purposes of soaking and washing pots, pans, and other related articles. Typically, such cooking articles are placed in a relatively-large sink filled with heated water and detergent and are permitted to soak therein for a predetermined period of time. The cleaning fluid is continuously removed from and re-circulated into the sink to create a turbulent washing action within the sink.

Examples of sinks used to wash pots, pans and like articles are provided by U.S. Pat. No. 4,773,436 issued to Cantrell et al.; U.S. Pat. No. 6,739,348 B2 issued to Inch et al.; D.415,323 issued to Rastelli; U.S. Pat. Nos. 5,775,347, 5,810,036 and 5,927,309 issued to Hoover et al.; U.S. Pat. No. 6,659,114 B2 issued to Bigott; U.S. Pat. No. 5,660,194 issued to Sanders; U.S. Pat. No. 6,289,530 B1 issued to Miller et al.; U.S. Pat. No. 2,669,240 issued to Thorson; U.S. Pat. No. 2,632,452 issued to Spitzer; and U.S. Pat. No. 3,863,657 issued to Irving.

Although the aforementioned washers may function in a satisfactory manner for their intended purposes, there is a need for a washing apparatus and method that provides an improved cleaning fluid flow pattern for the efficient cleaning of articles, such as pots and pans. The cleaning fluid flow pattern created in the apparatus should prevent pots and pans from piling-up and becoming jammed against a wall, corner or bottom of the apparatus. The cleaning fluid flow pattern should permit free circulation of the pots and pans within the sink to ensure maximum cleaning efficiency.

### SUMMARY OF THE INVENTION

The present invention is an apparatus for soaking pots, pans and related articles in a cleaning fluid. The apparatus is an open-topped sink having a front wall, a rear wall, an opposed pair of sidewalls, and vertically-extending corner sections connecting the front and rear walls to the sidewalls. The apparatus also includes a pump for circulating cleaning fluid from the sink to at least one nozzle located in each corner section of the sink. Cleaning fluid is pumped under pressure through each nozzle to create a whirlpool circulation pattern within the sink. Preferably, the corner sections are formed as chamfers, or are rounded, and each nozzle is directed to emit a flow of cleaning fluid substantially parallel to and closely along an adjacent one of the front, rear and sidewalls of the sink. Preferably, the flows of cleaning fluid are directed within two to three inches of the adjacent one of the front, rear and sidewalls of the sink.

According to another aspect of the present invention, a method for washing pots and pans is provided. The method includes filling a sink with a cleaning fluid and soaking pots and pans in the cleaning fluid within the sink for a predetermined period of time. The sink has an open top, a front wall, a rear wall, an opposed pair of sidewalls, and four vertically-extending corner sections that connect the front and rear walls to the sidewalls. During the soaking step, cleaning fluid is continuously withdrawn from the sink and pumped under pressure back into the sink via a plurality of nozzles to create a whirlpool circulation pattern in the sink. The nozzles are located only in the corner sections such that each nozzle directs a flow of cleaning fluid in a direction substantially parallel to and closely along an adjacent one of the front, rear and sidewalls. Preferably, each corner section is formed as a chamfer or is rounded.

### BRIEF DESCRIPTION OF THE DRAWINGS

The foregoing and other objects, features and advantages of the present invention should become apparent from the following description when taken in conjunction with the accompanying drawings, in which:

FIG. 1 is a plan view of a power soak sink according to the present invention

FIG. 2 is a front elevational view of the power soak sink of FIG. 1;

FIG. 3 is a partially cut-away side elevational view of the power soak sink of FIG. 1;

FIG. 4 is a rear elevational view of the power soak sink of FIG. 1;

FIG. 5 is an enlarged, cross-sectional view of a corner of the power soak sink illustrated in FIG. 1; and

FIG. 5A is an alternate embodiment of a corner of a power soak sink according to the present invention.

### DETAILED DESCRIPTION OF THE INVENTION

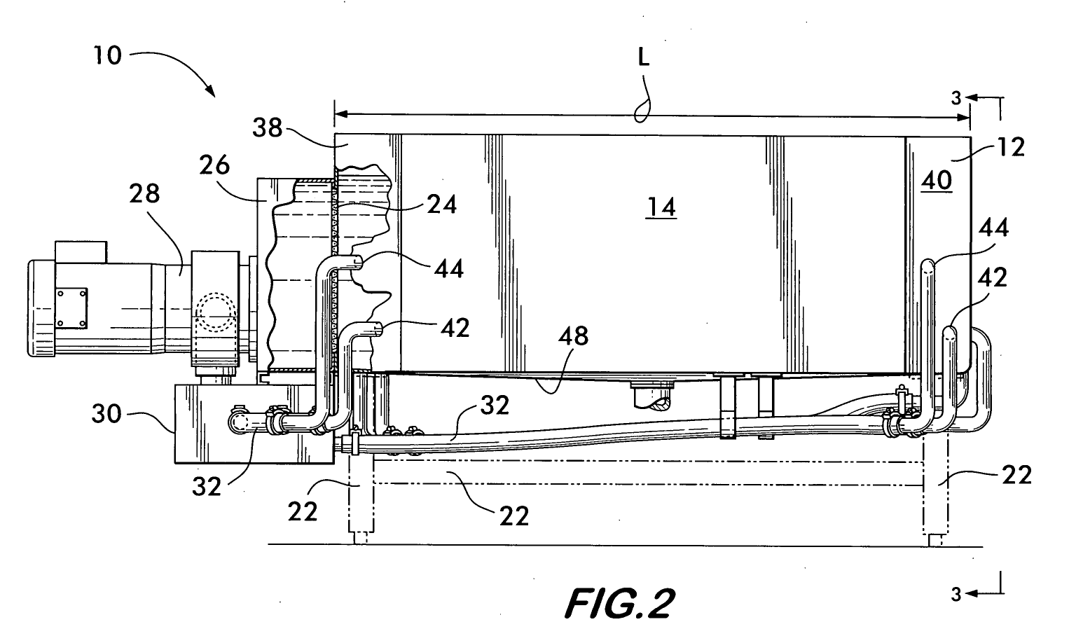

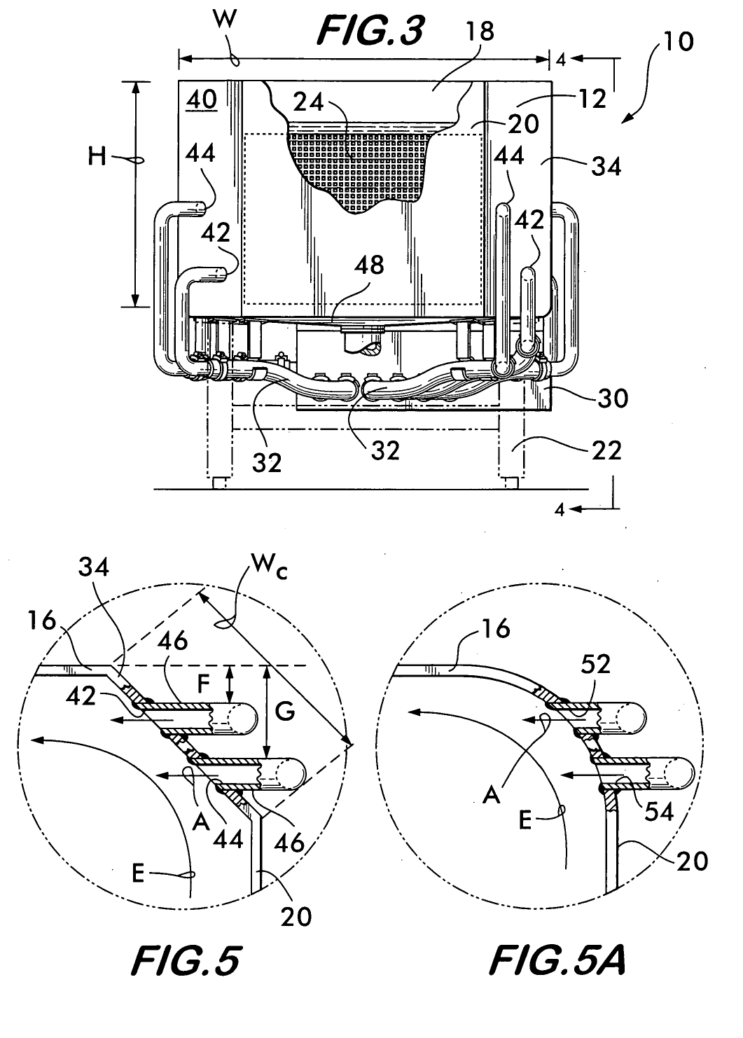

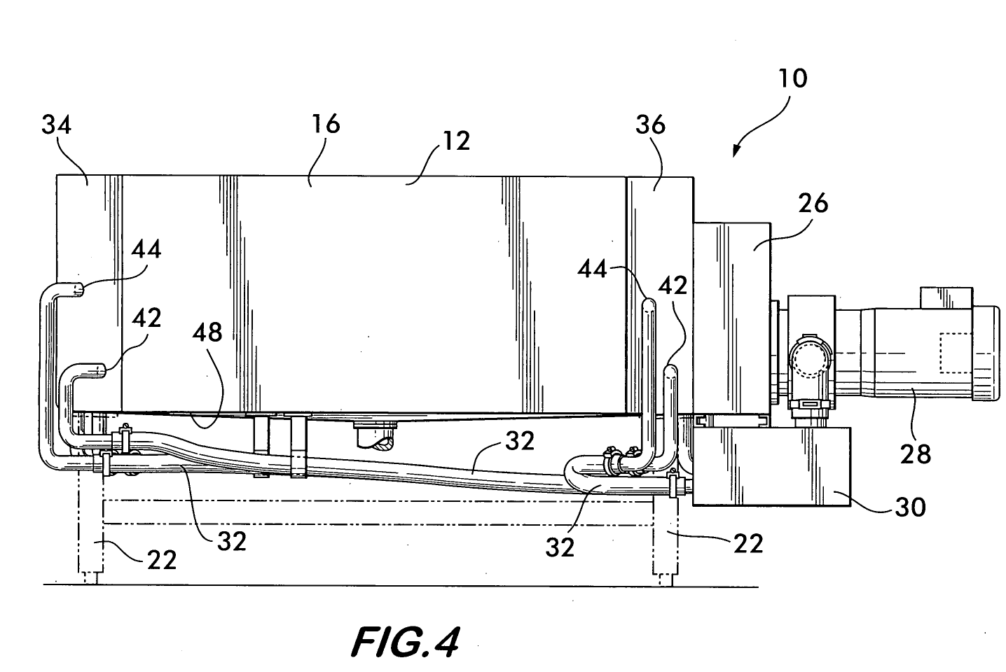

The washing apparatus 10 according to the present invention is a relatively large, open-topped, substantially rectangular sink, or tank, 12 having a front wall 14, a rear wall 16, and sidewalls 18 and 20. As illustrated with dashed lines in FIGS. 2-4, the sink 12 can be supported on a legged support frame 22. Preferably, the sink 12 is made of stainless steel, or like material, and is of a dimension sufficient for soaking and washing pots, pans and other relatively large kitchen articles. By way of example, the sink 12 can have a height “H” of eighteen inches, a length “L” of forty-eight inches, and a width “W” of twenty-eight inches. Of course, other dimensions and tank shapes can also be utilized.

The sidewall 18 includes perforations 24 that permit the flow of a fluid from within the sink 12 to a return manifold 26. A pump 28 is connected to the sink 12 adjacent sidewall 18 and pumps fluid from the return manifold 26 to a pump discharge manifold 30. A plurality of conduits 32 extend from the manifold 30 to nozzles formed in the walls of the sink 12, which are discussed below in greater detail. Thus, when the sink 12 is filled with a cleaning fluid, such as a detergent mixed in warm water, the pump 28 continuously withdraws fluid from the sink 12 through the perforated sidewall 18 and returns the fluid under pressure to the sink 12 via a series of nozzles thereby creating a turbulent flow of fluid within the sink 12.

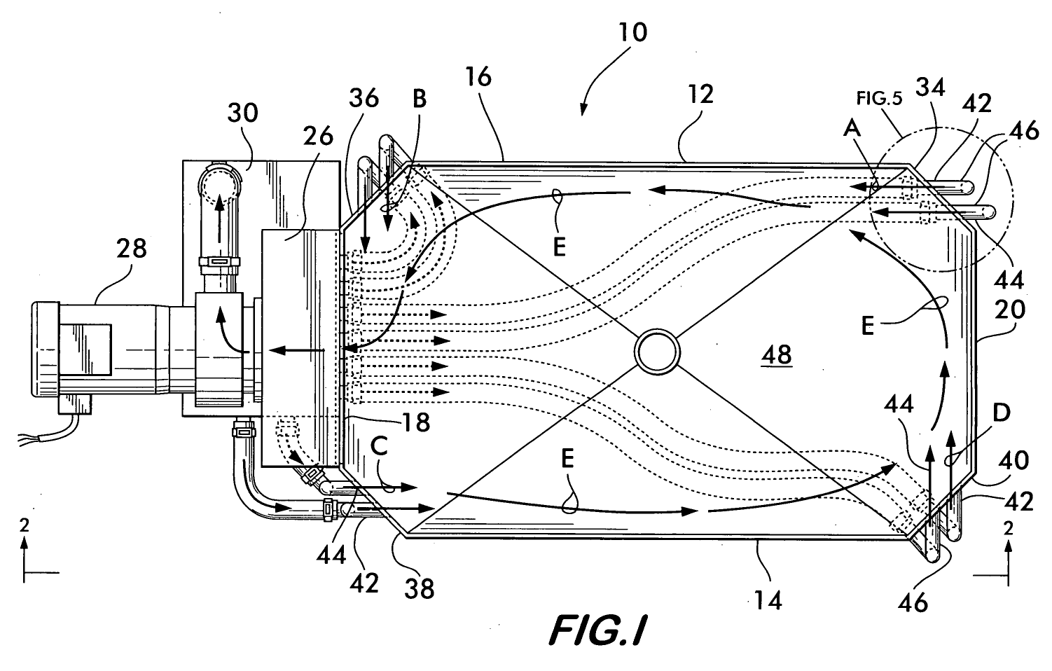

As best illustrated in FIG. 1, the four vertically-extending corners 34, 36, 38 and 40 of the sink 12 are formed as chamfers thereby providing beveled or truncated corners. Each chamfer 34, 36, 38 and 40 provides a relatively-large flat surface. By way of example, each corner can be formed as a 45° chamfer and have a width “Wc” of about 7 inches. Of course, other angle and sized chamfers can be utilized. The use of beveled or truncated corners eliminates tight corners in which pots and pans can become jammed.

Nozzles, or openings, 42 and 44, are formed in each chamfer, 34, 36, 38 and 40. As best illustrated in FIG. 5, the nozzles 42 and 44 are recessed relative to the chamfer so that pots and pans cannot become caught on any part of a nozzle. A portion 46 of each conduit 32 adjacent to the openings, 42 and 44, is disposed substantially parallel to an adjacent wall of the sink 12 so that the flow of fluid discharged through openings 42 and 44 is directed along and parallel to an adjacent wall of the sink 12. For example, the nozzles in chamfer 34 direct fluid along and parallel to the rear wall 16 (see arrows “A”), the nozzles in chamfer 36 direct fluid along and parallel to the sidewall 18 (see arrows “B”), the nozzles in chamfer 38 direct fluid along and parallel to the front wall 14 (see arrows “C”), and the nozzles in chamfer 40 direct fluid along and parallel to the sidewall 20 (see arrows “D”) thereby generating a whirlpool flow pattern in sink 12 (see arrows “E”).

Preferably, there are two nozzles, or openings, 42 and 44, in each chamfer which are located close to the adjacent wall of the sink. For example, nozzles 42 and 44 illustrated in FIG. 5 preferably eject, or emit, fluid at about two to about three inches from the rear wall 16 of the sink (see dimensions “F” and “G” in FIG. 5). The close spacing of the nozzles to the adjacent wall of the sink prevent “dead” spots from being created along the walls of the sink 12 and enhance the free circulation of pots and pans within the sink 12. In addition, preferably the nozzles 42 and 44 are located at different elevations along the chamfers. By way of example, nozzle 42 can be located about three inches above the base 48 of the sink 12 and nozzle 44 can be located about eight inches above the base 48. Of course, other numbers and patterns of nozzles can be utilized.

An alternate embodiment of a corner 50 of a sink according to the present invention is illustrated in FIG. 5A. The rounded corner 50 is arcuate in horizontal cross-section. Nozzles, or openings, 52 and 54 are located in arcuate corner 50 similar to how nozzles 42 and 44 are located within chamfer 34 discussed above.

The sink 12 discussed above enables pots and pans to be efficiently cleaned. To this end, the method of cleaning includes filling the sink 12 with a cleaning fluid and creating a whirlpool flow pattern in sink 12 by pumping cleaning fluid under pressure through nozzles located only in the four corners of the sink. Each corner is beveled or rounded, and the nozzles emit a flow of fluid in a direction substantially parallel to the adjacent wall of the sink thereby creating a whirlpool flow pattern within the sink. The nozzles are located about two to three inches from the adjacent walls of the sink and are recessed relative to the walls of the sink.

Pots and pans, which require cleaning are placed in the cleaning fluid in the sink 12 and are permitted to soak and circulate in the cleaning fluid. The elimination of tight corners, the use of recessed nozzles, and the location and direction of the nozzles eliminates the pots and pans from becoming jammed or piling-up within the sink. Thus, the pots and pans are free to continuously circulate within the turbulent whirlpool flow of cleaning fluid and are thereby efficiently cleaned.

While a preferred power soak sink and method of cleaning pots and pans have been described in detail, various modifications, alterations, and changes may be made without departing from the spirit and scope of the sink and method according to the present invention as defined in the appended claims.

1. Apparatus for soaking pots, pans and related articles in a cleaning fluid, comprising:
an open-topped sink having a front wall, a rear wall, an opposed pair of sidewalls, and vertically-extending corner sections connecting said front and rear walls to said sidewalls;
a pump for circulating cleaning fluid within the sink; and
at least one nozzle in each corner section through which cleaning fluid is pumped under pressure by said pump to create a whirlpool circulation pattern within the sink.

2. Apparatus according to claim 1, wherein said nozzles through which cleaning fluid is pumped into the sink are only located on said corner sections and not on said front wall, rear wall, or sidewalls.

3. Apparatus according to claim 1, wherein each corner section is arcuate in horizontal cross-section.

4. Apparatus according to claim 1, wherein each corner section is formed as a chamfer.

5. Apparatus according to claim 4, wherein each chamfer is a planar 45° chamfer having a width of at least about seven inches.

6. Apparatus according to claim 1, wherein said nozzles are recessed in said corner sections and do not extend into the sink.

7. Apparatus according to claim 1, wherein each of said nozzles directs a flow of cleaning fluid in a direction substantially parallel to an adjacent one of said front, rear and sidewalls, such that a flow of cleaning fluid is directed along each of said front, rear and sidewalls of the sink to create a whirlpool circulation pattern in the sink.

8. Apparatus according to claim 7, wherein said nozzles are located on said corner sections such that the flows of cleaning fluid directed by said nozzles along each of said front, rear and sidewalls are directed within three inches of said front, rear and sidewalls.

9. Apparatus according to claim 1, wherein a pair of nozzles are located in each corner section.

10. Apparatus according to claim 9, wherein each pair of nozzles includes nozzles located at different elevations relative to a base of said sink.

11. Apparatus for washing pots and pans in a cleaning fluid, comprising:
an open-topped sink having a front wall, a rear wall, and an opposed pair of sidewalls, said sink is substantially rectangular except for four vertically-extending corner sections that connect said front and rear walls to said sidewalls, said corner sections being formed as chamfers;
at least one nozzle recessed in each of said four chamfers, each nozzle being closely located to an adjacent one of said front, rear and sidewalls to direct a flow of cleaning fluid in a direction substantially parallel to and along said adjacent one of said front, rear and sidewalls, such that a flow of cleaning fluid is directed along each of said front, rear and sidewalls of the sink to create a whirlpool circulation pattern in the sink; and
a pump for pumping cleaning fluid withdrawn from the sink to said nozzles.

12. Apparatus according to claim 11, wherein said nozzles located on said chamfers are the only nozzles through which cleaning fluid is pumped into the sink.

13. Apparatus according to claim 12, wherein each chamfer is a planar 45° chamfer having a width of at least about seven inches.

14. Apparatus according to claim 13, wherein said nozzles are located on said chamfers about two to about three inches from said adjacent one of said front, rear and sidewall along which the flow of cleaning fluid is directed.

15. Apparatus according to claim 14, wherein a pair of nozzles are located in each chamfer at different elevations relative to a base of said sink.

16. Apparatus according to claim 15, wherein one of said sidewalls is perforated and communicates with a return manifold.

17. Apparatus according to claim 16, wherein said pump continuously pumps cleaning fluid under pressure from said return manifold to a discharge manifold which communicates with said nozzles via a plurality of conduits.

18. A method of washing pots and pans, comprising:
filling a sink with a cleaning fluid, said sink having an open top, a front wall, a rear wall, an opposed pair of sidewalls, and four vertically-extending corner sections that connect said front and rear walls to said sidewalls;
soaking the pots and pans in the cleaning fluid within the sink for a predetermined period of time;
during said soaking step, continuously withdrawing cleaning fluid from the sink and pumping the withdrawn cleaning fluid under pressure back into the sink via a plurality of nozzles to create a whirlpool circulation pattern in the sink, said nozzles being located only in said corner sections such that each nozzle directs a flow of cleaning fluid in a direction substantially parallel to and along an adjacent one of said front, rear and sidewalls.

19. A method according to claim 18, wherein said corner sections are formed as chamfers and said flow of cleaning fluid directed by each nozzle along said front, rear and sidewalls are directed within two to three inches from said front, rear and sidewalls by said nozzles.

20. A method according to claim 19, wherein a pair of nozzles are located in each chamfer for directing a pair of flows of cleaning fluid at different elevations along said adjacent one of said front, rear and sidewalls.
